(19) United States
(12) Patent Application Publication
(10) Pub. No.: US 2019/0280890 A1
(43) Pub. Date: Sep. 12, 2019

(54) TRANSPORT SYSTEM, INFORMATION PROCESSING APPARATUS, AND INFORMATION PROCESSING METHOD

(71) Applicant: TOYOTA JIDOSHA KABUSHIKI KAISHA, Toyota-shi (JP)

(72) Inventors: Takahiro MUTA, Mishima-shi (JP); Eisuke ANDO, Nagoya-shi (JP); Takao HISHIKAWA, Nagoya-shi (JP)

(73) Assignee: TOYOTA JIDOSHA KABUSHIKI KAISHA, Toyota-shi (JP)

(21) Appl. No.: 16/290,264

(22) Filed: Mar. 1, 2019

(30) Foreign Application Priority Data
Mar. 6, 2018 (JP) 2018-039496

(51) Int. Cl. H04L 12/28; G06F 16/9035; G06K 9/00; G06F 21/32; G06N 20/00; G06N 5/04

(52) U.S. Cl. CPC H04L 12/2829; G06F 16/9035; G06N 5/04; G06F 21/32; G06N 20/00; G06K 9/00624

(57) ABSTRACT

A transport system includes a mobile body including a room and an environment adjusting device that adjusts an environment of the room, and an information processing apparatus including a processor configured to provide, on the basis of identification information for identifying a user who uses the room, adjustment information for adjusting the environment of the room for each user to the mobile body.

### CROSS-REFERENCE TO RELATED APPLICATION

This application claims the benefit of Japanese Patent Application No. 2018-039496, filed on Mar. 6, 2018, which is hereby incorporated by reference herein in its entirety.

### BACKGROUND

### Technical Field

The present disclosure relates to a transport system, an information processing apparatus, an information processing method, and a program.

### Description of the Related Art

Conventionally, a mobile office which has an effective office function and which can easily move and be placed has been proposed.

### CITATION LIST

### Patent Document

Patent document 1: Japanese Patent Laid-Open No. H09-183334

By the way, an environment suitable for a user differs depending on the user. Therefore, there occurs time and effort for adjusting an environment of a room provided at a mobile body exemplified by a mobile office. In one aspect, an object of the present disclosure is to reduce time and effort for adjusting an environment of a room when a user utilizes the room provided at a mobile body.

### SUMMARY

In one aspect, the present disclosure is exemplified by a transport system. The present transport system includes a mobile body including a room and an environment adjusting device that adjusts an environment of the room, and an information processing apparatus including a processor configured to that provide, on the basis of identification information for identifying a user who uses the room, adjustment information for adjusting the environment of the room for each user to the mobile body. According to the present transport system, because the information processing apparatus provides the adjustment information for adjusting the environment of the room for each user, and the environment adjusting device adjusts the environment of the room in accordance with the provided adjustment information, it is possible to reduce time and effort for adjusting the environment of the room.

In another aspect, the information processing apparatus may further include a storage configured to store the adjustment information set for each user in association with the identification information of the user. According to the present transport system, the information processing apparatus can acquire the adjustment information for each user from the storage and provide the adjustment information to the mobile body.

Further, in another aspect, the processor of the information processing apparatus may be configured to: acquire physical condition information indicating a physical condition of the user; correct the adjustment information on the basis of the acquired physical condition information; and provide the corrected adjustment information to the mobile body. According to the present transport system, because the information processing apparatus corrects the adjustment information in accordance with the physical condition of the user, and the mobile body adjusts the environment of the room in accordance with the corrected adjustment information, it is possible to provide the environment of the room in accordance with the physical condition of the user, to the user.

Further, in another aspect, the environment adjusting device may include one or more types of equipment which controls one of lighting of the room, daylighting from outside the room, view of outside from the room, a volume of acoustic equipment, air conditioning, a height of a chair to be used by the user, tilt of a back of the chair, a height of a desk to be used by the user, display content of a display, and vibration characteristics of the room in association with movement of the mobile body. According to the present transport system, it is possible to adjust the environment of the room with the equipment as described above and provide the environment of the room to the user.

In another aspect, the physical condition information may include at least one of a heart rate, a blood pressure, a blood flow rate, an electrical signal obtained from a body, a body temperature, and judgement information based on image recognition. According to the present transport system, it is possible to provide the environment of the room in accordance with the physical condition information of the user as described above, to the user.

Further, in another aspect, the processor of the information processing apparatus may be configured to acquire the physical condition information of the user through measurement equipment provided within the room at a predetermined timing, and correct the adjustment information on the basis of the physical condition information acquired at the predetermined timing. The present transport system can provide the environment corrected on the basis of the physical condition information acquired at the predetermined timing, to the user.

Still further, in another aspect, the processor of the information processing apparatus may be configured to acquire action schedule of the user within the room, and correct the adjustment information in accordance with the acquired action schedule. The present transport system can provide the environment of the room in accordance with the action schedule of the user, to the user.

Another aspect of the present disclosure is also exemplified by the above-described information processing apparatus. Further, another aspect of the present disclosure is also exemplified by an information processing method executed by a computer such as the above-described information processing apparatus. Still further, another aspect of the present disclosure is also exemplified by a program to be executed by a computer such as the above-described information processing apparatus.

According to the present mobile body system, it is possible to reduce time and effort for adjusting an environment of a room when a user utilizes the room provided at a mobile body.

### BRIEF DESCRIPTION OF DRAWINGS

FIG. 1 is a diagram illustrating a configuration of a transport system;

FIG. 2 is a perspective view illustrating appearance of an EV palette;

FIG. 3 is a schematic plan view illustrating a configuration of indoor space of the EV palette;

FIG. 4 is a plan view of arrangement of a sensor, a display, a drive apparatus and a control system mounted on the EV palette, seen from a lower side of the EV palette;

FIG. 5 is a diagram illustrating a configuration of the control system and each component relating to the control system;

FIG. 6 is a diagram illustrating a detailed configuration of a biosensor and an environment adjusting unit;

FIG. 7 is a diagram illustrating a hardware configuration of a management server;

FIG. 8 is a block diagram illustrating a logical configuration of the management server;

FIG. 9 is a diagram illustrating a configuration of an environment information DB:

FIG. 10 is a diagram illustrating a configuration of a schedule DB;

FIG. 11 is a flowchart illustrating palette reservation processing;

FIG. 12 is a flowchart illustrating palette utilization processing;

FIG. 13 is a flowchart illustrating environment information adjustment processing by monitoring.

### DESCRIPTION OF THE EMBODIMENT

A transport system according to one embodiment and an information processing method executed in this transport system will be described below with reference to the drawings.

<Ev Palette>

In the present embodiment, a self-propelled electric vehicle called an electric vehicle (EV) palette provides various functions or service to a user in cooperation with a computer system on a network. The EV palette of the present embodiment (hereinafter, simply referred to as an EV palette) is a mobile body which can perform automated driving and unmanned driving. The EV palette of the present embodiment provides a room to a user who is on board. An environment of the room provided by the present EV palette is adjusted so as to match desire of the user. Environment information for adjusting the environment of this room is stored in a server on a network.

Further, the EV palette has an information processing apparatus and a communication apparatus for controlling the EV palette, providing a user interface with a user who utilizes the EV palette, transmitting and receiving information with various kinds of servers on a network, or the like. The EV palette provides functions and services added by various kinds of servers on the network to the user in addition to processing which can be executed by the EV palette alone, in cooperation with various kinds of servers on the network.

Therefore, when the user newly starts to use the EV palette, the EV palette adjusts the environment of the room on the basis of the environment information acquired from the server on the network. Further, for example, the user can change an EV palette to be used in accordance with purpose of use of the EV palette, application, an on-board object to be mounted on the EV palette, the number of passengers, or the like. In the transport system of the present embodiment, even if the user changes an EV palette to be used, the changed EV palette adjusts the environment of the room on the basis of the environment information acquired from the server on the network. In this case, a first server which holds the environment information and a second server which provides a function or service to the user in cooperation with the EV palette may be different servers or the same server. In either case, the replaced EV palette provides an environment similar to that provided by the EV palette before replacement, on the basis of the environment information held on the network.

Further, in the present embodiment, the server on the network acquires physical condition information indicating a physical condition of the user from the user and adjusts the environment information of the room in accordance with the physical condition of the user. For example, in the case where the user is determined to be excited from a heart rate and a respiration rate of the user, the server corrects the environment information so as to calm the excitement of the user through air conditioning and sound. Further, in the present embodiment, the server acquires action schedule of the user and corrects the environment information of the room in accordance with the action schedule of the user. For example, the server provides the corrected environment information to the EV palette, and the EV palette adjusts the environment of the room provided at the EV palette on the basis of the environment information provided from the server. For example, the EV palette makes lighting of the room bright during office work, and dims lighting of the room to atmosphere similar to that of a restaurant before dinner.

<Configuration>

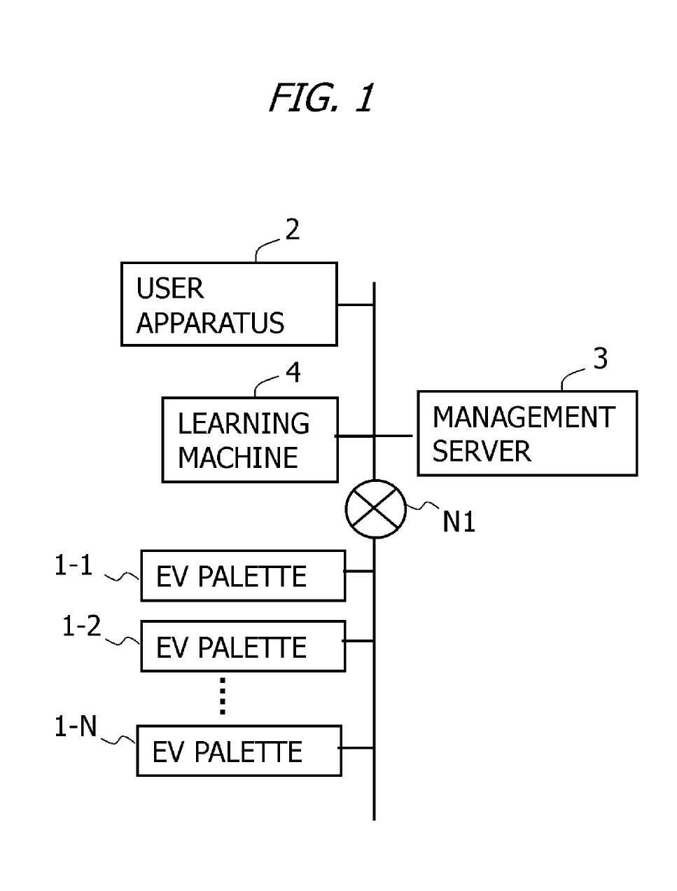

FIG. 1 illustrates a configuration of the present transport system. The present transport system includes a plurality of EV palettes 1-1, 1-2, . . . , 1-N, a management server 3 connected to the plurality of EV palettes 1-1, or the like, through a network N1, and learning machine 4. Hereinafter, in the case where the plurality of EV palettes 1-1, or the like, are referred to as without distinction, they will be collectively simply referred to as an EV palette 1. Further, a user apparatus 2 is connected to the network N1. The EV palette 1 is one example of the mobile body. However, the mobile body is not limited to the EV palette 1. The mobile body may be, for example, a car, a ship, an airplane, or the like.

The network N1 is a public communication network, and is, for example, the Internet. The network N1 may include a wired communication network and a wireless communication network. The wireless communication network is, for example, a communication network of each mobile phone company. However, part of the wireless communication network may include, a wireless Local Area Network (LAN), or the like. Further, the wired communication network is a communication network provided by a communication carrier. However, the wired communication network may include a wired LAN.

The EV palette 1 is a mobile body which carries persons or goods and which can perform automated driving and unmanned driving. The EV palette 1 has a graphical user interface (GUI) by computer control, accepts a request from the user, responds to the user, executes predetermined processing in response to the request from the user and reports a processing result to the user. For example, the EV palette 1 accepts speech, an image or an instruction by the user from input/output equipment of a computer and executes processing.

However, the EV palette 1 notifies the management server 3 of the request from the user for a request which is unable to be processed by the EV palette 1 alone among the requests from the user and executes processing in cooperation with the management server 3. Examples of the request which is unable to be processed by the EV palette 1 alone includes, for example, requests for acquisition of information from a database on the management server 3, recognition or inference by the learning machine 4, or the like. It can be said that the EV palette 1 is one example of a plurality of mobile bodies. For example, the EV palette 1 accepts a reservation request from the user via the GUI, registers in the management server 3 that indoor space of the EV palette 1 is used as a room. Further, the EV palette 1 sets and registers in the management server 3, environment information for adjusting an environment of the indoor space of the EV palette 1 to be used as the room in response to the request from the user.

The user accesses the management server 3 via the GUI of the EV palette 1, a user apparatus 2, or the like, before using the EV palette 1, and requests reservation of one of the EV palettes 1. In response to this request, the management server 3 registers relationship between the user and the EV palette 1 which is reserved and which is to be used by the user in a database. In the present embodiment, the EV palette 1 which is reserved by the user and for which the relationship between the user and the EV palette 1 to be used by the user is registered in the management server 3 will be referred to as my palette. However, the user can replace my palette to another EV palette 1 in accordance with purpose of use, or the like, of the user.

The user apparatus 2 is, for example, a mobile phone, a smartphone, a mobile information terminal, a tablet terminal, a personal computer, or the like. The user apparatus 2 accepts a request from the user, responds to the user, executes predetermined processing in response to the request from the user, and reports a processing result to the user. The user apparatus 2, for example, accesses the management server 3, or the like, on the network N1 in cooperation with the EV palette 1 or in place of the user interface of the EV palette 1, and provides various kinds of processing, functions or service to the user. For example, the user apparatus 2 accepts a reservation request from the user in place of the user interface of the EV palette 1, and registers my palette which is the EV palette 1 for which indoor space is to be used as a room, in the management server 3. Further, the user apparatus 2 sets and registers in the management server 3, environment information for adjusting an environment of the indoor space of the EV palette 1 to be used as a room in response to the request from the user.

The management server 3 provides various kinds of processing, functions or service to the user in cooperation with the EV palette 1 which is registered as my palette. For example, the management server 3 accepts environment information for setting an environment of indoor space of the EV palette 1 to be used as a room for each user and stores the environment information in the database in association with identification information of the user. Then, when the user uses the EV palette, the management server 3 acquires the environment information stored for each user and provides the environment information to the EV palette 1 to be used by the user.

Therefore, when the user uses the EV palette 1, the EV palette 1 can adjust an environment of the indoor space of the EV palette 1 to be used as a room in accordance with the environment information provided from the management server 3. Here, the environment refers to physical, chemical or biological conditions which are felt by the user through five senses and which affect a living body of the user. Examples of the environment can include, for example, brightness within the room, dimming, daylighting from outside, view from a window of the room, a temperature, humidity, an air volume of air conditioning, whether or not there is sound, a type and a volume of the sound, display content of a display, aroma, characteristics of a suspension which supports the room, or the like.

Further, the management server 3 acquires physical condition information (also referred to as biological information) indicating a physical condition of the user, corrects the environment information on the basis of the acquired physical condition information and provides the environment information to the EV palette 1. Here, the environment information before correction will be also referred to as reference information. The management server 3 may acquire the physical condition information of the user by input from the user through the user apparatus 2 or the GUI of the EV palette 1. Further, the management server 3 can acquire the physical condition information of the user through various kinds of equipment within the EV palette 1 at a predetermined timing.

Further, the management server 3 can acquire action schedule of the user and can correct the environment information in accordance with the action schedule. Here, the management server 3 may acquire the action schedule from, for example, the management server 3 itself or a schedule database which cooperates with the management server 3. Further, the management server 3 may acquire future action schedule of the user by input from the user through the user apparatus 2 or the GUI of the EV palette 1. Therefore, the management server 3 can correct the environment information (reference information) in accordance with at least one of the physical condition and the action schedule of the user and can provide the environment information to the EV palette 1 to be used by the user.

The learning machine 4 executes inference processing, recognition processing, or the like, by a request from the management server 3. For example, the learning machine 4 is an information processing apparatus which has a neural network having a plurality of layers and which executes deep learning. That is, the learning machine 4 executes convolution processing of receiving input of a parameter sequence {xi, i=1, 2, . . . , N} and performing product-sum operation on the input parameter sequence with a weighting coefficient {wi, j, l, (here, j is a value between 1 and an element count M to be subjected to convolution operation, and l is a value between 1 and the number of layers L)} and pooling processing which is processing of decimating part from an activating function for determining a result of the convolution processing and a determination result of the activating function for the convolution processing. The learning machine 4 repeatedly executes the processing described above over a plurality of layers L and outputs an output parameter (or an output parameter sequence) {yk, k=1, . . . , P} at a fully connected layer in a final stage. In this case, the input parameter sequence {xi} is, for example, a pixel sequence which is one frame of an image, a data sequence indicating a speech signal, a string of words included in natural language, or the like. Further, the output parameter (or the output parameter sequence) {yk} is, for example, a characteristic portion of an image which is an input parameter, a defect in the image, a classification result of the image, a characteristic portion in speech data, a classification result of speech, an estimation result obtained from a string of words, or the like.

The learning machine 4 receives input of a number of combinations of existing input parameter sequences and correct output values (training data) and executes learning processing in supervised learning. Further, the learning machine 4, for example, executes processing of clustering or abstracting the input parameter sequence in unsupervised learning. In learning processing, coefficients {wi, j, l} in the respective layers are adjusted so that a result obtained by executing convolution processing (and output by an activating function) in each layer, pooling processing and processing in the fully connected layer on the existing input parameter sequence approaches a correct output value. Adjustment of the coefficients {wi, j, l} in the respective layers is executed by letting an error based on a difference between output in the fully connected layer and the correct output value propagate from an upper layer to a lower input layer. Then, by an unknown input parameter sequence {xi} being input in a state where the coefficients {wi, j, l} in the respective layers are adjusted, the learning machine 4 outputs a recognition result, a determination result, a classification result, an inference result, or the like, for the unknown input parameter sequence {xi}.

For example, the learning machine 4 extracts a face portion of the user from an image frame acquired by the EV palette 1. Further, the learning machine 4 recognizes speech of the user from speech data acquired by the EV palette 1 and accepts a command by the speech. Still further, the learning machine 4 determines a physical condition of the user from an image of the face of the user and generates physical condition information. The physical condition information generated by the learning machine 4 is, for example, classification for classifying the image of the face portion of the user and, is exemplified as good, slightly good, normal, slightly bad, bad, or the like. The image may be, for example, one which indicates temperature distribution of a face surface obtained from an infrared camera. The learning machine 4 may report the determined physical condition information of the user to the management server 3, and the management server 3 may correct the environment information on the basis of the reported physical condition information. Note that, in the present embodiment, learning executed by the learning machine 4 is not limited to machine learning by deep learning, and the learning machine 4 may execute learning by typical perceptron, learning by other neural networks, search using genetic algorithm, or the like, statistical processing, or the like.

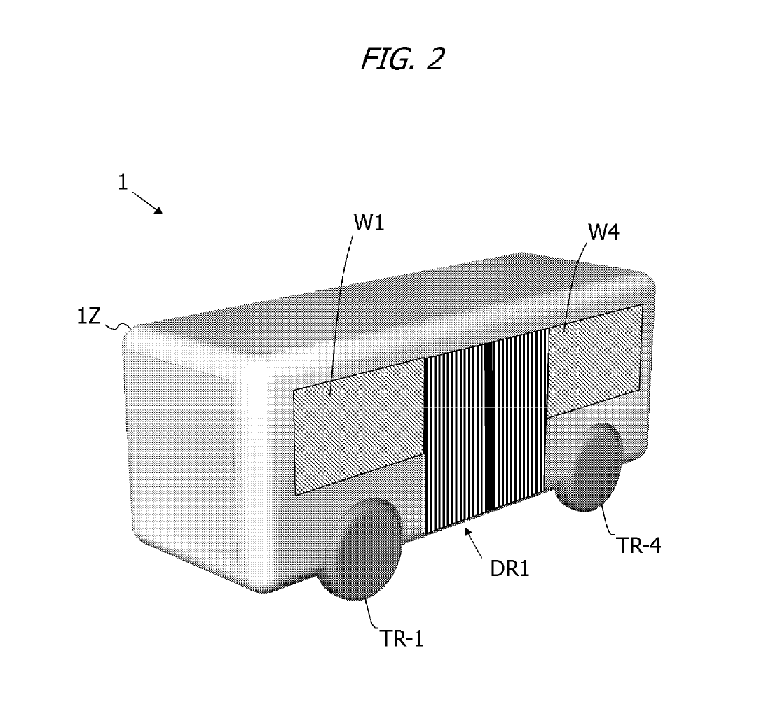

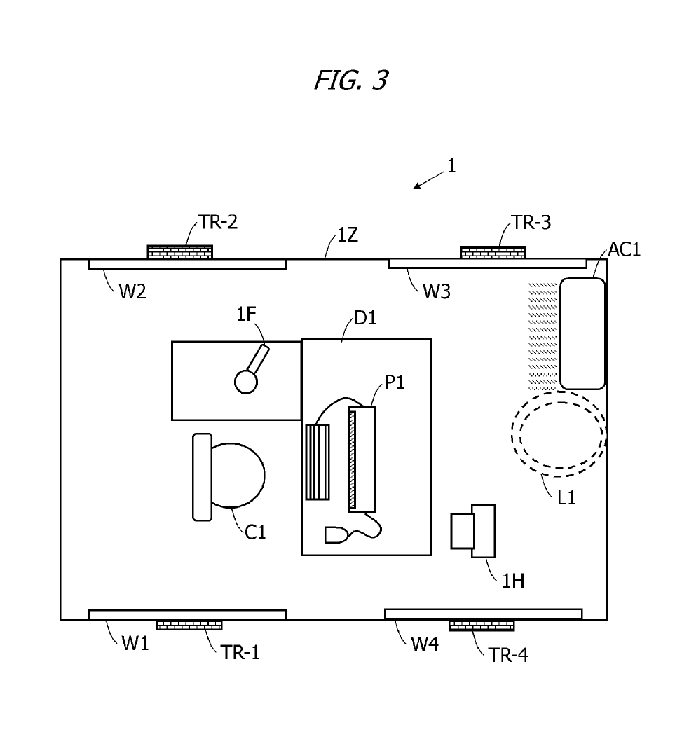

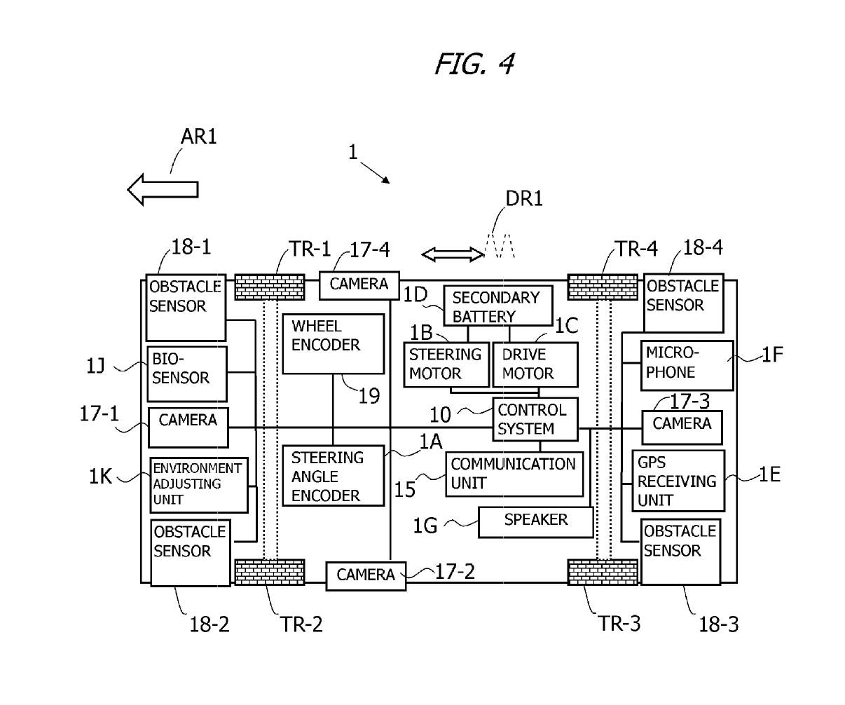

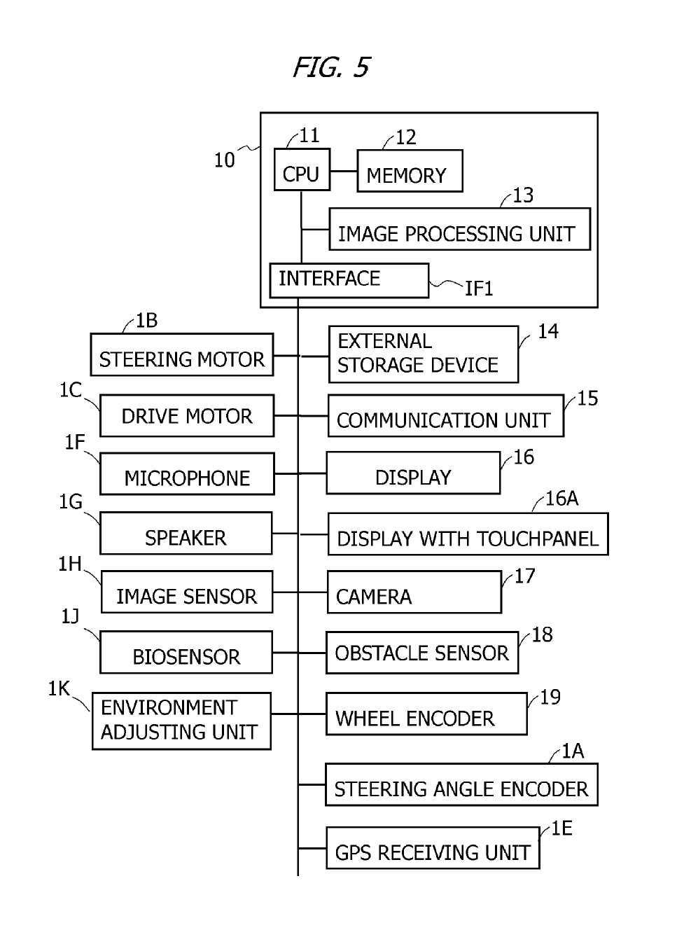

FIG. 2 is a perspective view illustrating appearance of the EV palette 1. FIG. 3 is a schematic plan view (view of indoor space seen from a ceiling side of the EV palette 1) illustrating a configuration of the indoor space of the EV palette 1. FIG. 4 is a diagram illustrating a plan view of arrangement of a sensor, a display, a drive apparatus and a control system mounted on the EV palette 1, seen from a lower side of the EV palette 1. FIG. 5 is a diagram illustrating a configuration of the control system 10 and each component relating to the control system 10.

The EV palette 1 includes a boxlike body 1Z, and four wheels TR1 to TR4 provided at anterior and posterior portions in a traveling direction at both sides of a lower part of the body 1Z. The four wheels TR1 to TR4 are coupled to a drive shaft which is not illustrated and are driven by a drive motor 1C illustrated in FIG. 4. Further, the traveling direction upon traveling of the four wheels TR1 to TR4 (a direction parallel to a plane of rotation of the four wheels TR1 to TR4) is displaced relatively with respect to the body 1Z by a steering motor 1B illustrated in FIG. 4, so that the traveling direction is controlled.

As illustrated in FIG. 3, the indoor space of the EV palette 1 provides facility as a room to the user. The EV palette 1 includes a desk D1, a chair C1, a personal computer P1, a microphone 1F, an image sensor 1H, an air conditioner AC1 and a ceiling light L1 in the indoor space. Further, the EV palette 1 has windows W1 to W4 at the boxlike body 1Z. The user who is on board the EV palette 1 utilizes the indoor space as a room while the EV palette 1 moves, and can, for example, do office work. For example, the user sits on the chair C1 and performs document creation, transmission and reception of information with outside, or the like, using the personal computer P1 on the desk D1.

The EV palette 1 of the present embodiment provides the indoor space to the user as a room. The EV palette 1 adjusts an environment of this indoor space in accordance with the environment information provided from the management server 3. For example, the desk D1 has an actuator which adjusts a height. Further, the chair C1 has an actuator which adjusts a height and tilt of a back. Therefore, the EV palette 1 adjusts a height of an upper surface of the desk D1, a height of a seating surface and tilt of the back of the chair C1 in accordance with the environment information. Further, the windows W1 to W4 respectively have actuators which drive curtains or window shades. Therefore, the EV palette 1 adjusts daylighting from the windows (that is, from outside of the room) and view of outside of the EV palette 1 from the windows in accordance with the environment information. Further, the EV palette 1 adjusts dimming of the ceiling light L1 and a temperature and humidity of the indoor space with the air conditioner AC1 in accordance with the environment information. Still further, the EV palette 1 acquires speech, an image and biological information of the user with the microphone 1F, the image sensor 1H and a biosensor 1J illustrated in FIG. 4 and transmits the speech, the image and the biological information to the management server 3. The management server 3 corrects the environment information in accordance with the speech, the image and the biological information of the user transmitted from the EV palette 1 and feeds back the environment information to the EV palette 1.

Now, it is assumed in FIG. 4 that the EV palette 1 travels in a direction of an arrow AR1. Therefore, it is assumed that a left direction in FIG. 4 is a traveling direction. Therefore, in FIG. 4, a side surface on the traveling direction side of the body 1Z is referred to as a front surface of the EV palette 1, and a side surface in a direction opposite to the traveling direction is referred to as a back surface of the EV palette 1. Further, a side surface on a right side of the traveling direction of the body 1Z is referred to as a right side surface, and a side surface on a left side is referred to as a left side surface.

As illustrated in FIG. 4, the EV palette 1 has obstacle sensors 18-1 and 18-2 at locations close to corner portions on both sides on the front surface, and has obstacle sensors 18-3 and 18-4 at locations close to corner portions on both sides on the back surface. Further, the EV palette 1 has cameras 17-1, 17-2, 17-3 and 17-4 respectively on the front surface, the left side surface, the back surface and the right side surface. In the case where the obstacle sensors 18-1, or the like, are referred to without distinction, they will be collectively referred to as an obstacle sensor 18 in the present embodiment. Further, in the case where the cameras 17-1, 17-2, 17-3 and 17-4 are referred to without distinction, they will be collectively referred to as a camera 17 in the present embodiment.

Further, the EV palette 1 includes the steering motor 1B, the drive motor 1C, and a secondary battery 1D which supplies power to the steering motor 1B and the drive motor 1C. Further, the EV palette 1 includes a wheel encoder 19 which detects a rotation angle of the wheel each second, and a steering angle encoder 1A which detects a steering angle which is the traveling direction of the wheel. Still further, the EV palette 1 includes the control system 10, a communication unit 15, a GPS receiving unit 1E, a microphone 1F and a speaker 1G. Note that, while not illustrated, the secondary battery 1D supplies power also to the control system 10, or the like. However, a power supply which supplies power to the control system 10, or the like, may be provided separately from the secondary battery 1D which supplies power to the steering motor 1B and the drive motor 1C. The speaker 1G is one example of acoustic equipment.

The control system 10 is also referred to as an Electronic Control Unit (ECU). As illustrated in FIG. 5, the control system 10 includes a CPU 11, a memory 12, an image processing unit 13 and an interface IF1. To the interface IF1, an external storage device 14, the communication unit 15, the display 16, a display with a touch panel 16A, the camera 17, the obstacle sensor 18, the wheel encoder 19, the steering angle encoder 1A, the steering motor 1B, the drive motor 1C, the GPS receiving unit 1E, the microphone 1F, the speaker 1G, an image sensor 1H, a biosensor 1J, an environment adjusting unit 1K, or the like, are connected.

The obstacle sensor 18 is an ultrasonic sensor, a radar, or the like. The obstacle sensor 18 emits an ultrasonic wave, an electromagnetic wave, or the like, in a detection target direction, and detects existence, a location, relative speed, or the like, of an obstacle in the detection target direction on the basis of a reflected wave.

The camera 17 is an imaging apparatus using an image sensor such as Charged-Coupled Devices (CCD) and a Metal-Oxide-Semiconductor (MOS) or a Complementary Metal-Oxide-Semiconductor (CMOS). The camera 17 acquires an image at predetermined time intervals called a frame period, and stores the image in a frame buffer which is not illustrated, within the control system 10. An image stored in the frame buffer with a frame period is referred to as frame data.

The steering motor 1B controls a direction of a cross line on which a plane of rotation of the wheel intersects with a horizontal plane, that is, an angle which becomes a traveling direction by rotation of the wheel, in accordance with an instruction signal from the control system 10. The drive motor 1C, for example, drives and rotates the wheels TR1 to TR4 in accordance with the instruction signal from the control system 10. However, the drive motor 1C may drive one pair of wheels TR1 and TR2 or the other pair of wheels TR3 and TR4 among the wheels TR1 to TR4. The secondary battery 1D supplies power to the steering motor 1B, the drive motor 1C and parts connected to the control system 10.

The steering angle encoder 1A detects a direction of the cross line on which the plane of rotation of the wheel intersects with the horizontal plane (or an angle of the rotating shaft of the wheel within the horizontal plane), which becomes the traveling direction by rotation of the wheel, at predetermined detection time intervals, and stores the direction in a register which is not illustrated, in the control system 10. In this case, for example, a direction to which the rotating shaft of the wheel is orthogonal with respect to the traveling direction (direction of the arrow AR1) in FIG. 4 is set as an origin of the traveling direction (angle). However, setting of the origin is not limited, and the traveling direction (the direction of the arrow AR1) in FIG. 4 may be set as the origin. Further, the wheel encoder 19 acquires rotation speed of the wheel at predetermined detection time intervals, and stores the rotation speed in a register which is not illustrated, in the control system 10.

The communication unit 15 communicates with, for example, various kinds of servers, or the like, on a network N1 through a mobile phone base station and a public communication network connected to the mobile phone base station. The global positioning system (GPS) receiving unit 1E receives radio waves of time signals from a plurality of satellites (Global Positioning Satellites) which orbit the earth and stores the radio waves in a register which is not illustrated, in the control system 10. The microphone 1F detects sound or speech (also referred to as acoustic), converts the sound or speech into a digital signal and stores the digital signal in a register which is not illustrated, in the control system 10. The speaker 1G is driven by a D/A converter and an amplifier connected to the control system 10 or a signal processing unit which is not illustrated, and reproduces acoustic including sound and speech.

The CPU 11 of the control system 10 executes a computer program expanded at the memory 12 so as to be able to be executed, and executes processing as the control system 10. The memory 12 stores a computer program to be executed by the CPU 11, data to be processed by the CPU 11, or the like. The memory 12 is, for example, a Dynamic Random Access Memory (DRAM), a Static Random Access Memory (SRAM), a Read Only Memory (ROM), or the like. The image processing unit 13 processes data in the frame buffer obtained for each predetermined frame period from the camera 17 in cooperation with the CPU 11. The image processing unit 13, for example, includes a GPU and an image memory which becomes the frame buffer. The external storage device 14, which is a non-volatile main memory, is, for example, a Solid State Drive (SSD), a hard disk drive, or the like.

For example, as illustrated in FIG. 5, the control system 10 acquires a detection signal from a sensor of each unit of the EV palette 1 via the interface IF1. Further, the control system 10 calculates latitude and longitude which is a location on the earth from the detection signal from the GPS receiving unit 1E. Still further, the control system 10 acquires map data from a map information database stored in the external storage device 14, matches the calculated latitude and longitude to a location on the map data and determines a current location. Further, the control system 10 acquires a route to a destination from the current location on the map data. Still further, the control system 10 detects an obstacle around the EV palette 1 on the basis of signals from the obstacle sensor 18, the camera 17, or the like, determines the traveling direction so as to avoid the obstacle and controls the steering angle.

Further, the control system 10 processes images acquired from the camera 17 for each frame data in cooperation with the image processing unit 13, for example, detects change based on a difference in images and recognizes an obstacle.

Still further, the control system 10 displays an image, characters and other information on the display 16. Further, the control system 10 detects operation to the display with the touch panel 16A and accepts an instruction from the user. Further, the control system 10 responds to the instruction from the user via the display with the touch panel 16A, the camera 17 and the microphone 1F, from the display 16, the display with the touch panel 16A or the speaker 1G.

Further, the control system 10 acquires a face image of the user in the indoor space from the image sensor 1H and notifies the management server 3. The image sensor 1H is an imaging apparatus by the image sensor as with the camera 17. However, the image sensor 1H may be an infrared camera. Further, the control system 10 acquires the biological information of the user via the biosensor 1J and notifies the management server 3. Further, the control system 10 adjusts the environment of the indoor space via the environment adjusting unit 1K in accordance with the environment information notified from the management server 3.

While the interface IF1 is illustrated in FIG. 5, a path for transmission and reception of signals between the control system 10 and a control target is not limited to the interface IF1. That is, the control system 10 may have a plurality of signal transmission and reception paths other than the interface IF1. Further, in FIG. 5, the control system 10 has a single CPU 11. However, the CPU is not limited to a single processor and may employ a multiprocessor configuration. Further, a single CPU connected with a single socket may employ a multicore configuration. Processing of at least part of the above-described units may be executed by processors other than the CPU, for example, at a dedicated processor such as a Digital Signal Processor (DSP) and a Graphics Processing Unit (GPU). Further, at least part of processing of the above-described units may be an integrated circuit (IC) or other digital circuits. Still further, at least part of the above-described units may include analog circuits.

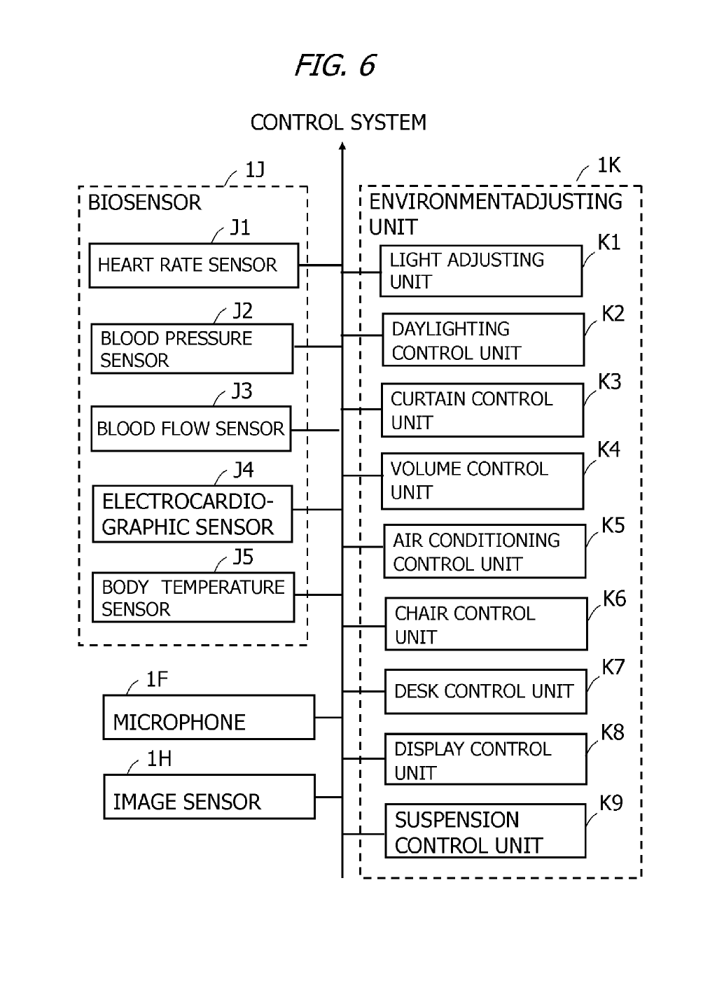

FIG. 6 is a diagram illustrating detailed configurations of the biosensor 1J and the environment adjusting unit 1K. FIG. 6 illustrates the microphone 1F and the image sensor 1H as well as the biosensor 1J and the environment adjusting unit 1K. The control system 10 acquires information relating to the physical condition of the user from the microphone 1F, the image sensor 1H and the biosensor 1J and notifies the management server 3.

As illustrated in FIG. 6, the biosensor 1J includes at least one of a heart rate sensor J1, a blood pressure sensor J2, a blood flow sensor J3, an electrocardiographic sensor J4 and a body temperature sensor J5. That is, the biosensor 1J is a combination of one or a plurality of these sensors. However, the biosensor 1J of the present embodiment is not limited to the configuration in FIG. 6. In the present transport system, in the case where a function of correcting the environment information on the basis of the physical condition of the user is utilized, the microphone 1F acquires speech of the user, or the image sensor acquires an image of the user. Further, the user may wear the biosensor 1J on the body of the user.

The heart rate sensor J1, which is also referred to as a heart rate meter or a brain wave sensor, irradiates blood vessels of the human body with a Light Emitting Diode (LED), and specifies a heart rate from change of the blood flow with the reflected light. The heart rate sensor J1 is, for example, worn on the body such as the wrist of the user. Note that the blood flow sensor J3 has a light source (laser) and a light receiving unit (photodiode) and measures a blood flow rate on the basis of Doppler shift from scattering light from moving hemoglobin. Therefore, the heart rate sensor J1 and the blood flow sensor J3 can share a detecting unit.

The blood pressure sensor J2 has a compression garment (cuff) which performs compression by air being pumped after the compression garment is wound around the upper arm, a pump which pumps air to the cuff, and a pressure sensor which measures a pressure of the cuff, and determines a blood pressure on the basis of fluctuation of the pressure of the cuff which is in synchronization with heart beat of the heart in a depressurization stage after the cuff is compressed once (oscillometric method). However, the blood pressure sensor J2 may be one which shares a detecting unit with the above-described heart rate sensor J1 and blood flow sensor J3 and which has a signal processing unit that converts the change of the blood flow detected at the detecting unit into a blood pressure.

The electrocardiographic sensor J4 has an electrode and an amplifier, and acquires an electrical signal generated from the heart by being worn on the breast. The body temperature sensor J5, which is a so-called electronic thermometer, measures a body temperature in a state where the body temperature sensor J5 contacts with a body surface of the user. However, the body temperature sensor J5 may be infrared thermography. That is, the body temperature sensor J5 may be one which collects infrared light emitted from the face, or the like, of the user, and measures a temperature on the basis of luminance of the infrared light radiated from a surface of the face.

The environment adjusting unit 1K includes at least one of a light adjusting unit K1, a daylighting control unit K2, a curtain control unit K3, a volume control unit K4, an air conditioning control unit K5, a chair control unit K6, a desk control unit K7, a display control unit K8 and a suspension control unit K9. That is, the environment adjusting unit 1K is a combination of one or a plurality of these control units. However, the environment adjusting unit 1K of the present embodiment is not limited to the configuration in FIG. 6. The environment adjusting unit 1K controls each unit within the EV palette 1 in accordance with the environment information for each user provided from the management server 3 and adjusts the environment. The above-described each control unit included in the environment adjusting unit 1K is one example of the equipment.

The light adjusting unit K1 controls the LED built in the ceiling light L1 in accordance with a light amount designated value and a light wavelength component designated value included in the environment information and adjusts a light amount and a wavelength component of light emitted from the ceiling light L1. The daylighting control unit K2 instructs the actuators of the window shades provided at the windows W1 to W4 and adjusts daylighting and view from the windows W1 to W4 in accordance with a daylighting designated value included in the environment information. Here, the daylighting designated value is, for example, a value designating an opening degree (from fully opened to closed) of the window shade. In a similar manner, the curtain control unit K3 instructs the actuators of the curtains provided at the windows W1 to W4 and adjusts opened/closed states of the curtains at the windows W1 to W4 in accordance with an opening designated value for the curtain included in the environment information. Here, the opening designated value is, for example, a value designating an opening degree (fully opened to closed) of the curtain.

The volume control unit K4 adjusts sound quality and a volume of sound output by the control system 10 from the speaker 1G in accordance with a sound designated value included in the environment information. Here, the sound designated value is, for example, whether or not a high frequency or a low frequency is emphasized, a degree of emphasis, a degree of an echo effect, a volume maximum value, a volume minimum value, or the like.

The air conditioning control unit K5 adjusts an air volume from the air conditioner AC1 and a set temperature in accordance with an air conditioning designated value included in the environment information. Further, the air conditioning control unit K5 controls ON or OFF of a dehumidification function at the air conditioner AC1 in accordance with the environment information. The chair control unit K6 instructs the actuator of the chair C1 to adjust a height of the seating surface and tilt of the back of the chair C1 in accordance with the environment information. The desk control unit K7 instructs the actuator of the desk D1 to adjust a height of an upper surface of the desk D1 in accordance with the environment information. The suspension control unit K9 is a control apparatus of a so-called active suspension. In the case where implementation of the active suspension is designated in the environment information, the suspension control unit K9 instructs the actuator which supports a vehicle interior, generates force in an opposite direction with respect to shaking of the EV palette 1 to suppress vibration in association with movement of the EV palette 1. Whether or not the active suspension is implemented is one example of the vibration characteristics.

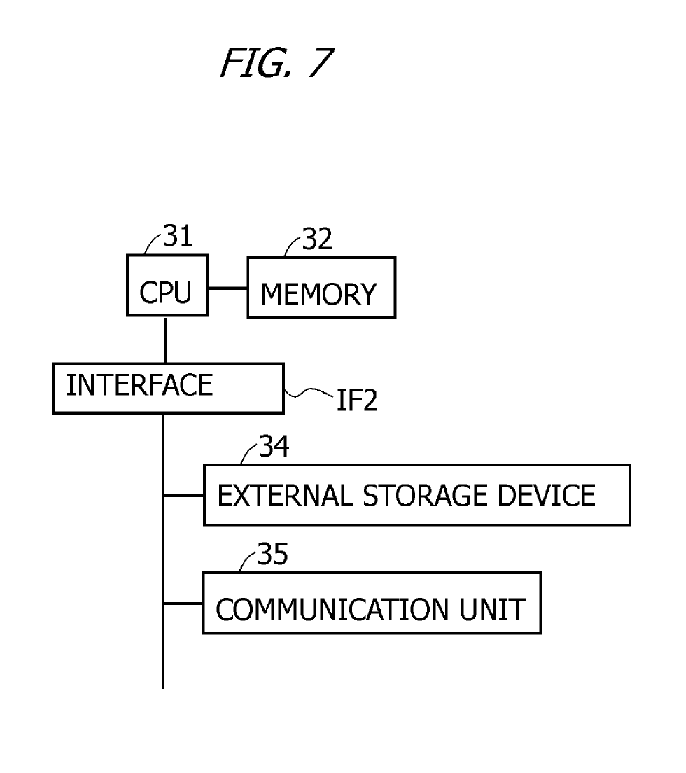

FIG. 7 is a diagram illustrating a hardware configuration of the management server 3. The management server 3 includes a CPU 31, a memory 32, an interface IF2, an external storage device 34, and a communication unit 35. The configurations and operation of the CPU 31, the memory 32, the interface IF2, the external storage device 34 and the communication unit 35 are similar to those of the CPU 11, the memory 12, the interface IF1, the external storage device 14 and the communication unit 15 in FIG. 5. Further, the configuration of the user apparatus 2 is also similar to that of the management server 3 in FIG. 7. However, the user apparatus 2 may include, for example, a touch panel as an input unit which accepts user operation. Further, the user apparatus 2 may include a display and a speaker as an output unit for providing information to the user.

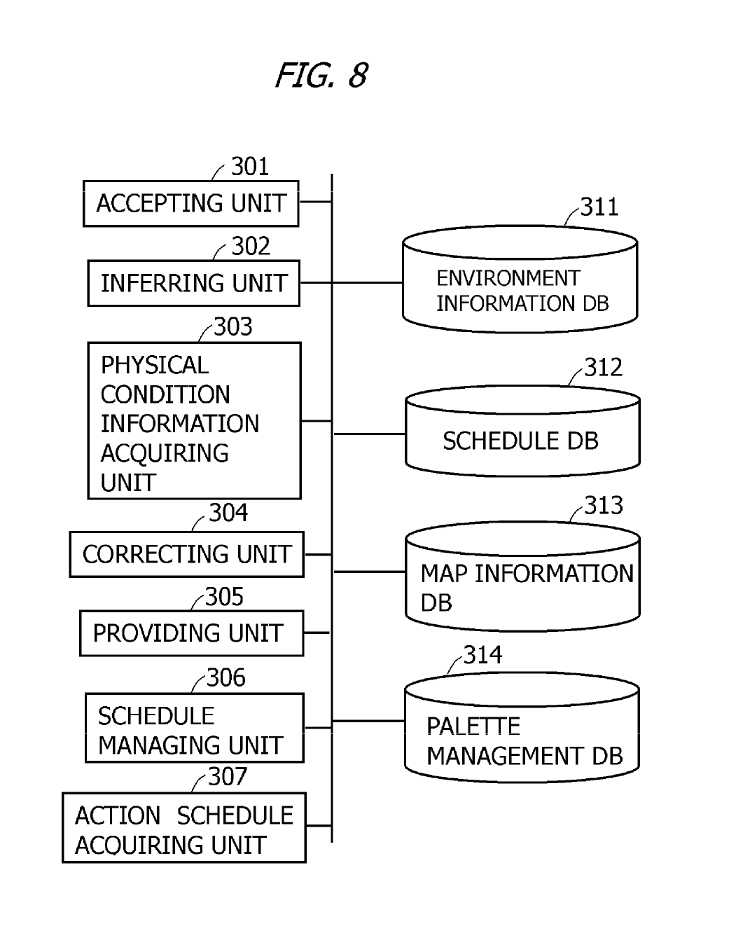

FIG. 8 is a block diagram illustrating a logical configuration of the management server 3. The management server 3 operates as each unit illustrated in FIG. 8 by a computer program on the memory 32. That is, the management server 3 includes an accepting unit 301, an inferring unit 302, a physical condition information acquiring unit 303, a correcting unit 304, a providing unit 305, a schedule managing unit 306, an action schedule acquiring unit 307, an environment information database (DB 311), a schedule database (DB 312), a map information database (DB 313) and a palette management database (DB 314). Note that, in FIG. 8, a database is indicated as a DB.

The accepting unit 301 accepts a request from the EV palette 1 through the communication unit 35. The request from the EV palette 1 is, for example, a request for the environment information to the EV palette by the environment information DB 311. Further, the request from the EV palette 1 is a request for processing which is difficult to be processed by the EV palette 1 alone, for example, processing of performing execution in cooperation with the learning machine 4. For example, the accepting unit 301 accepts a request for processing of reserving the EV palette 1 which becomes my palette from the EV palette 1 or the user apparatus 2.

The inferring unit 302 executes processing, or the like, to be executed in cooperation with the learning machine 4. The processing to be executed in cooperation with the learning machine 4 is, for example, processing of determining a physical condition of the user on the basis of information of the image of the user, information of temperature distribution by infrared light, or the like. Further, after processing is completed in response to the request from the EV palette 1, the inferring unit 302 receives feedback information from the EV palette 1, transmits the received feedback information to the learning machine 4 and causes the learning machine 4 to execute further learning. That is, the inferring unit 302, for example, causes the learning machine 4 to execute deep learning and adjust a weight coefficient using the feedback information as training data for the input parameter sequence on which the learning machine 4 has performed recognition processing.

The physical condition information acquiring unit 303 acquires the physical condition information of the user when the user reserves usage of the EV palette or when the user starts to use the EV palette. For example, when the user reserves usage of the EV palette, the physical condition information acquiring unit 303 acquires the heart rate, the blood pressure, the blood flow, the image of the face, or the like, of the user via the user apparatus 2. Note that the user apparatus 2 may acquire the heart rate, the blood pressure, the blood flow, or the like, of the user via a wearable device such as a bracelet and a ring and notify the physical condition information acquiring unit 303.

Further, when the user starts to use the EV palette, the physical condition information acquiring unit 303 may acquire the speech of the user from the microphone 1F provided within the EV palette, the image of the user from the image sensor 1H and the physical condition information collected by the biosensor 1J. Note that, in the following description, the speech and the image of the user are included in the physical condition information of the user. As described above, it can be said that the physical condition information acquiring unit 303 acquires the physical condition information indicating the physical condition of the user.

Further, the physical condition information acquiring unit 303 acquires the physical condition information of the user from the user within the room, that is, within the indoor space at a predetermined timing while the user is on board the EV palette 1. The predetermined timing is a regular timing, for example, at predetermined time or at a predetermined time interval. However, the predetermined timing may be an irregular timing and may be, for example, after each meal, after sleep, after completion of predetermined work, or the like. Therefore, it can be said that the physical condition information acquiring unit 303 acquires the physical condition information of the user through measurement equipment provided within the room at a predetermined timing. Here, the measurement equipment is the microphone 1F, the image sensor 1H, the biosensor 1J, or the like.

The correcting unit 304 corrects the environment information in the environment information DB 311 on the basis of the physical condition information of the user. Further, the correcting unit 304 corrects the environment information in accordance with schedule of the user stored in the schedule DB 312 or work schedule input by the user from the GUI of the EV palette 1. For example, in the case where a temperature of the face surface of the user is high from the physical condition information of the user, the correcting unit 304 adjusts the environment information so that a room temperature is lowered. Further, for example, when the user is scheduled to do office work or read books, the correcting unit 304 adjusts the environment information so that the indoor space becomes bright. Still further, during a sleep scheduled time period, the correcting unit 304 suppresses the volume to be equal to or lower than a predetermined value. Further, the correcting unit 304 lowers the volume to 0 (mutes audio) during a meeting scheduled time period, a phone scheduled time period, or the like. Further, in the environment information, the active suspension may be turned OFF, and when carsick is recognized from color of the face of the user by the physical condition information acquiring unit 303 and the inferring unit 302, the correcting unit 304 may designate ON of the active suspension.

The providing unit 305 provides the environment information (reference information) stored in the environment information DB 311 for each user to the EV palette 1 when usage of the EV palette 1 is started. Further, the providing unit 305 provides the environment information corrected by the correcting unit 304 on the basis of the physical condition information of the user acquired by the physical condition information acquiring unit 303, to the EV palette 1 which is being used by the user.

The schedule managing unit 306 accepts input of schedule by the user from the GUI of the user apparatus 2 and stores the schedule in the schedule DB 312. The action schedule acquiring unit 307 acquires action schedule of the user who is on board the EV palette 1 from the schedule DB 312. Further, the action schedule acquiring unit 307 may encourage the user to input action schedule from the GUI of the user apparatus 2 and acquire future action schedule of the user. The action schedule acquiring unit 307 provides the acquired action schedule to the correcting unit 304.

The environment information DB 311 stores the environment information for adjusting the environment of the indoor space of the EV palette 1 for each user. The schedule DB 312 stores action schedule for each user in accordance with a date and a time slot. The map information DB 313 includes relationship between a symbol on the map and latitude and longitude, relationship between address and latitude and longitude, vector data which defines the road, or the like. The map information DB 313 is provided to the EV palette 1 and supports automated driving of the EV palette 1. The palette management DB 314 holds an attribute of each EV palette 1 in the present transport system. The attribute for each EV palette 1 is, for example, a palette ID, a type and application of the EV palette 1, a size, mileage upon full charge, or the like. Further, the palette management DB 314 holds date and time at which each EV palette 1 is reserved to avoid duplicate reservation.

<Data Example>

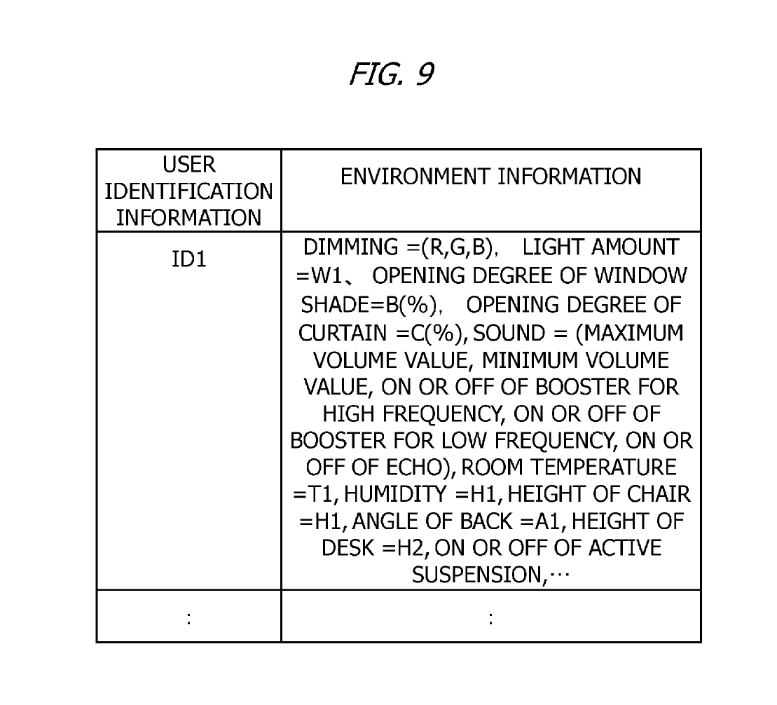

FIG. 9 is a diagram illustrating a configuration of the environment information DB 311. As illustrated, each record of the environment information DB 311 has user identification information and the environment information. The user identification information is information for uniquely identifying the user in the present transport system. The user identification information is, for example, information which is issued by the present transport system when the user is registered in the present transport system.

The environment information can be described in, for example, a key-value format. The environment information is dimming=(R, G, B), a light amount=W1, an opening degree of the window shade=B (%), an opening degree of the curtain=C (%), sound=(a maximum volume value, a minimum volume value, ON or OFF of a booster for a high frequency, ON or OFF of a booster for a low frequency, ON or OFF of echo), a room temperature=Tl, humidity=H1, a height of the chair=H1, an angle of the back=μl, a height of the desk=H2, ON or OFF of the active suspension, or the like. However, a fixed-length record including a plurality of elements can be used as the environment information. Further, in the environment information itself, pointers indicating entries of other tables may be set, and specific values may be set at entries of other tables. The user is also referred to as a user. The user identification information is one example of identification information for identifying the user who uses the room, and the environment information is one example of adjustment information for adjusting the environment of the room. As illustrated in FIG. 9, because the environment information DB 311 stores the environment information set for each user in association with the user identification information, it can be said that the environment information DB 311 is one example of a storage.

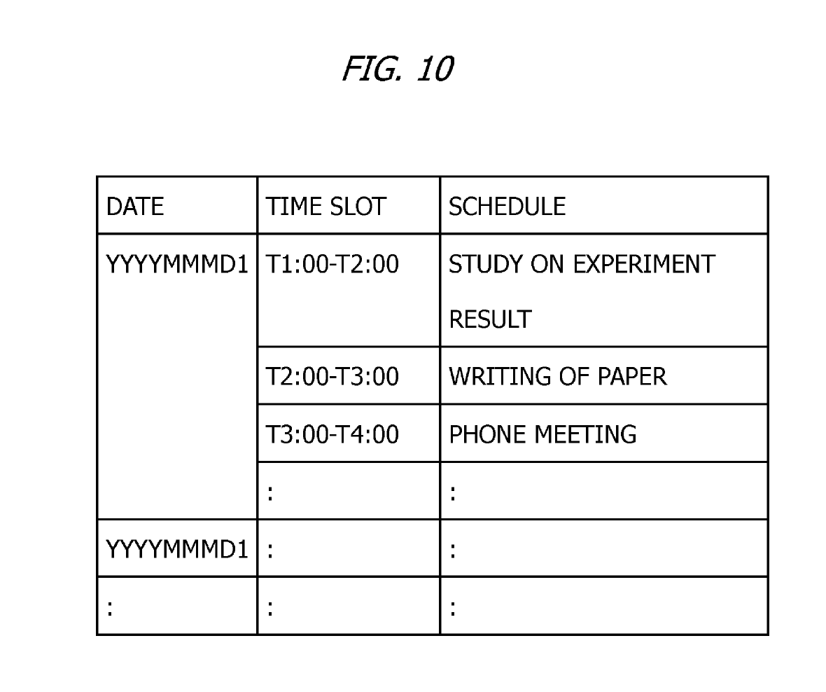

FIG. 10 is a diagram illustrating a configuration of the schedule DB 312. In the schedule DB 312, a table is created for each user. Each record in each table has date, a time slot and schedule. The date is date at which the schedule is set. The time slot is a time slot in which the schedule is set. The schedule is a character string indicating action schedule of the user on the corresponding date and time slot. However, in a field of the schedule, a code indicating the action schedule of the user may be set in place of the character string. Relationship between the code and an item indicating the action schedule of the user may be set in other definition tables.

<Processing Flow>

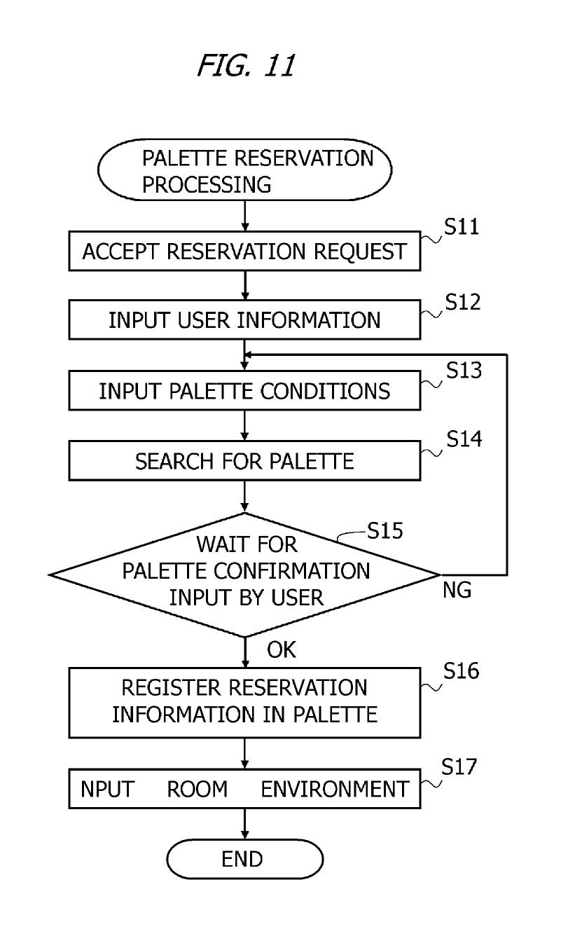

Processing flow in the transport system of the present embodiment will be described below with reference to FIG. 11 to FIG. 13. FIG. 11 is a flowchart illustrating palette reservation processing at the management server 3. The palette reservation processing is processing of the management server 3 allocating the EV palette 1 requested by the user on date and time requested by the user by the request from the user. The management server 3 executes the palette reservation processing by the accepting unit 301 (FIG. 8).

In the palette reservation processing, the management server 3 accepts a reservation request from the user apparatus 2 or the EV palette 1 (S11). For example, the user requests reservation to the management server 3 from a screen of the user apparatus 2. However, the user may request reservation to the management server 3 from a screen of the display with the touch panel 16A of the EV palette 1.

Then, the management server 3 requests input of user information to the screen of the user apparatus 2 (or the screen of the display with the touch panel 16A of the EV palette 1 (hereinafter, simply referred to as the user apparatus 2, or the like)) (S12). In input of the user information, the management server 3 requests input of the user identification information and authentication information to the user apparatus 2, or the like. The authentication information is information for confirming that the user identification information is registered in the transport system of the present embodiment. The authentication information is, for example, a password, biometric authentication information such as images of face, vein, fingerprint and iris, or the like. Therefore, it is assumed in the palette reservation processing that the user registration is completed and the user identification information and the authentication information have been registered in the management server 3.

Then, the management server 3 accepts input of conditions (hereinafter, palette conditions) of the EV palette 1 to be borrowed as my palette (S13). The palette conditions are, for example, a type and application of the EV palette 1, a size, mileage upon full charge, start date of borrowing, scheduled date of return, or the like. Then, the management server 3 searches the palette management DB 314 for the EV palette 1 which satisfies the input palette conditions (S14).

Then, the management server 3 displays a search result at the user apparatus 2, or the like, and waits for confirmation by the user (S15). In the case where the confirmation result of the user is NG, the management server 3 encourages the user to input palette conditions again to request resetting of the palette conditions (S13), and executes processing in S14 and the subsequent processing. Note that, at this time, to let the user give up reservation from the screen of the user apparatus 2, or the like, the management server 3 may encourage the user to cancel the reservation. Meanwhile, in the case where the confirmation result of the user is OK, the management server 3 registers reservation information (user identification information of the user for which the EV palette 1 has been reserved, start date of borrowing and scheduled date of return) in an entry of the EV palette 1 of the palette management DB 314 (S16).

Further, the management server 3 executes input of room environment information and storage in the environment information DB 311 (S17). In this processing, the management server 3 may display a default value of the environment information on the screen of the user apparatus 2, or the like, and request the user to make a confirmation response. Then, the management server 3 acquires the environment information confirmed by the user on the screen as to, for example, dimming=(R, G, B), a light amount=W1, . . . , or the like, and corrected as needed, from the screen. Then, the management server 3 stores the acquired environment information in the environment information DB 311.

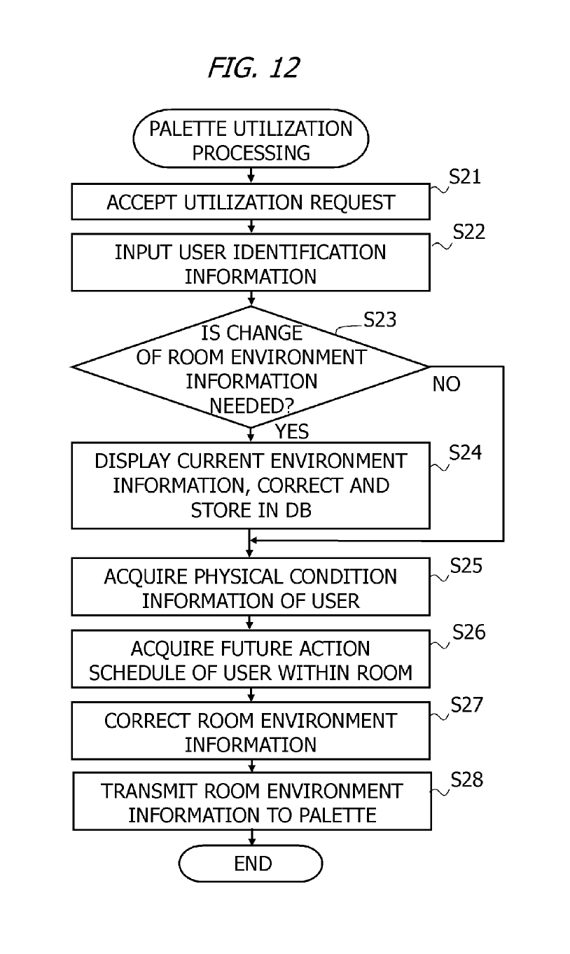

FIG. 12 is a flowchart illustrating palette utilization processing at the management server 3. The palette utilization processing is processing of the management server 3 accepting a utilization start request from the user via the GUI of the EV palette 1 and providing the environment information to the EV palette. In this processing, the management server 3 accepts the utilization start request from the user via the GUI of the EV palette 1 (S21). Then, the management server 3 accepts input of the user identification information of the user (S22).

Further, the management server 3 waits for confirmation as to whether or not change of the environment information of the room is needed (S23). In the case where change of the environment information of the room is needed, the management server 3 displays current environment information on the GUI, or the like, of the EV palette 1 and receives correction by the user. Then, the management server 3 stores the corrected environment information in the environment information DB 311 (S24).

Then, the management server 3 acquires the physical condition information of the user by the physical condition information acquiring unit 303 (S25). Further, the management server 3 acquires future action schedule of the user within the room by the action schedule acquiring unit 307 (S26). The action schedule acquiring unit 307 may, for example, acquire current and subsequent action schedule from the schedule DB 312. Further, the action schedule acquiring unit 307 may encourage the user to input action schedule from the GUI, or the like, of the EV palette 1 and acquire the input action schedule.

Then, the management server 3 corrects the environment information of the user by the correcting unit 304. The correcting unit 304 corrects the environment information in accordance with the physical condition information and work schedule of the user (S27). Then, the management server 3 transmits the environment information to the EV palette 1 to be used by the user by the providing unit 305 (S28). Then, the EV palette 1 adjusts the environment of the indoor space which is the room of the EV palette in accordance with the transmitted environment information.

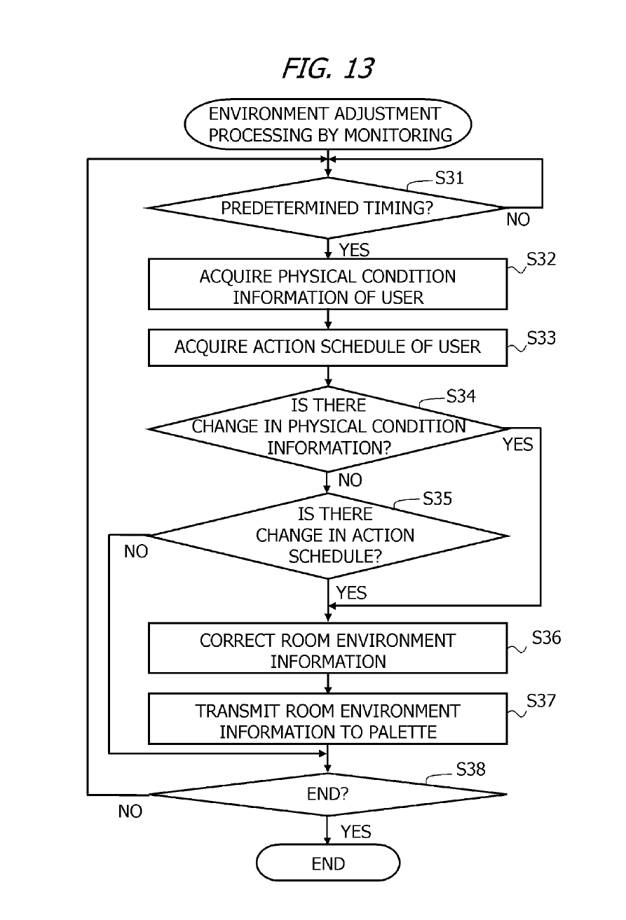

FIG. 13 is a flowchart illustrating environment information adjustment processing by monitoring. In the environment information adjustment processing by monitoring, the management server 3 monitors the physical condition information or the action schedule of the user and adjusts the environment information. In this processing, the management server 3 determines whether or not it is a predetermined timing (S31). When it is a predetermined timing, the management server 3 acquires the physical condition information of the user from the microphone 1F, the image sensor 1H and the biosensor 1J of the EV palette 1 by the physical condition information acquiring unit 303 (S32). Note that the management server 3 acquires the physical condition information of the user from speech and an image by causing the learning machine 4 to perform recognition processing on the speech of the user acquired from the microphone 1F and the image of the user acquired from the image sensor 1H. For example, the learning machine 4 may judge the physical condition of the user from a series of words (“tired”, “sleepy”, “refreshed”, or the like) in the speech of the user. Further, the learning machine 4 may judge the physical condition of the user (“carsick”, “fatigue”, “goodness”, or the like) from the face image of the user. Then, the management server 3 acquires future action schedule of the user by the action schedule acquiring unit 307 (S33). The processing in S31 and S32 is one example of acquiring the physical condition information of the user at a predetermined timing. The physical condition information acquired by the learning machine 4 through the image recognition processing is one example of the judgement information.

Then, the management server 3 determines whether or not there is change of equal to or greater than a predetermined limit in the physical condition information of the user (S34). In the case where there is change of equal to or greater than the predetermined limit in the physical condition information of the user, the management server 3 proceeds with the processing to S36. Here, the predetermined limit is registered in the memory 32 for each piece of physical condition information. The predetermined limit is, for example, increase by equal to or greater than 10, decrease by equal to or greater than 10, or the like, of the heart rate, as a relative value. Further, the predetermined limit is, for example, equal to or greater than 100, or the like, of the heart rate as an absolute value. Further, for example, in the case where there occurs change in a state of the user from the learning machine 4, it is judged that there is change of equal to or greater than the predetermined limit. In the case where there is no change of equal to or greater than the predetermined limit in the physical condition information of the user, the management server 3 determines whether or not there is change in the action schedule of the user (S35). In the case where there is no change in the action schedule of the user, the management server proceeds with the processing to S38.

Then, in the case where there is change in the action schedule of the user, or in the case where there is change of equal to or greater than the predetermined limit in the physical condition information of the user in the determination in S34, the management server 3 corrects the environment information of the room by the correcting unit 304 (S36).

Then, the management server 3 transmits the corrected environment information to the control system 10 of the EV palette 1 by the providing unit 305 (S37). Then, the management server 3 determines whether or not the processing is finished (S38). In the case where the processing is not finished, the management server 3 returns the processing to S31. Here, a case where the processing is finished is a case where the user returns the EV palette 1 which is my palette to the present transport system, or the like.

### Effects of Embodiment

According to the present embodiment, the management server 3 holds the environment information for each user and provides the environment information to the EV palette 1 to be used by the user, and the EV palette 1 adjusts an environment of the room, that is, the indoor space of the EV palette 1 in accordance with the environment information provided from the management server 3. Therefore, even in the case where the user borrows the EV palette 1 from the present transport system and uses the EV palette 1 for movement, it is possible to easily adjust the environment of the room. Accordingly, even in the case where the user boards the EV palette 1 and moves to a desired point through automated driving, it is possible to adjust the room within the EV palette 1 to an environment adapted to the user in a short period of time.

Further, because the environment information is stored in the environment information DB 311 managed by the management server 3, even in the case where the user uses a different EV palette 1, the same environment is provided for each user.

Further, because the management server 3 acquires the physical condition information of the user at a predetermined timing and corrects the environment information in accordance with the acquired physical condition information, it is possible to provide the environment information adapted to the physical condition of the user to the EV palette 1. Further, the EV palette 1 can set an environment adapted to the physical condition of the user at an appropriate timing and provide the environment to the user. For example, in the case where temperature distribution of the face surface of the user exhibits high distribution, the EV palette 1 may lower the room temperature by the air conditioner AC1. Further, for example, in the case where the temperature distribution of the face surface of the user exhibits low distribution, the EV palette 1 may suppress the air volume of the air conditioner AC1.

Further, because the management server 3 acquires the action schedule of the user and corrects the environment information in accordance with the acquired action schedule, it is possible to provide the environment information adapted to the action schedule of the user to the EV palette 1. For example, in the case where the user has a meal, sleeps, does office work, has a rest, or the like, the management server 3 can provide the environment information suitable for the action schedule to the EV palette 1, and the EV palette can provide the environment suitable for the action schedule.

For example, the EV palette 1 may control dimming so that the meal is made appetizing during the meal. Further, the EV palette 1 may adjust wavelength components so that lighting of the ceiling light L1 emits more yellow light rather than white light immediately before sleep. Further, the EV palette 1 may output relaxing music from the speaker 1G immediately before sleep. Still further, the EV palette 1 may suppress a volume from the speaker 1G to equal to or lower than a predetermined limit and make the lighting of the ceiling light L1 white light upon office work. Further, at rest, the EV palette 1 may output music which can relax the user from the speaker 1G and control the window shades or the curtains so as to provide a good view from the windows W1 to W4.

### Modified Example

In the above-described embodiment, the user reserves the EV palette 1 in advance and uses the EV palette 1 as a room. However, the service in the present transport system is not limited to such a method. For example, the user may make a usage request to the EV palette 1 which is moving around town through gesture or other instructions and make an authentication request to the management server 3 via a card reading device, or the like, of the EV palette 1 using a membership card, or the like, designating the user identification information. If authentication via the EV palette 1 is successful, the management server 3 may provide the indoor space of the EV palette 1 to the user as a room. Further, the management server 3 may accept the usage request via the user apparatus 2. With such a method, the present transport system can provide the indoor space of the EV palette 1 which is moving on the road or the EV palette 1 which stops at a predetermined waiting position, to the user as a room.

[Computer Readable Recording Medium]

It is possible to record a program which causes a computer, or other machine, apparatuses (hereinafter, a computer, or the like) to implement one of the above-described functions in a computer readable recording medium. Then, by causing the computer, or the like, to load and execute the program in this recording medium, it is possible to provide the function.

Here, the computer readable recording medium refers to a non-transitory recording medium in which information such as data and programs is accumulated through electric, magnetic, optical, mechanical or chemical action and from which the information can be read from a computer, or the like. Among such a recording medium, examples of a recording medium which is detachable from the computer, or the like, can include, for example, a flexible disk, a magnetooptical disk, a CD-ROM, a CD-R/W, a DVD, a blu-ray disk, a DAT, an 8 mm tape, a memory card such as a flash memory, or the like. Further, examples of a recording medium fixed at the computer, or the like, can include a hard disk, a ROM (read only memory), or the like. Still further, an SSD (Solid State Drive) can be utilized both as a recording medium which is detachable from the computer, or the like, and a recording medium which is fixed at the computer, or the like.

What is claimed is:

1. A transport system comprising:
a mobile body including a room and an environment adjusting device that adjusts an environment of the room; and
an information processing apparatus including a processor configured to provide, on a basis of identification information for identifying a user who uses the room, adjustment information for adjusting the environment of the room for each user to the mobile body.

2. The transport system according to claim 1,
wherein the information processing apparatus further comprises a storage configured to store the adjustment information set for each user in association with the identification information of the user.

3. The transport system according to claim 1,
wherein the processor is further configured to:
acquire physical condition information indicating a physical condition of the user;
correct the adjustment information on a basis of the acquired physical condition information; and
provide the corrected adjustment information to the mobile body.

4. The transport system according to claim 3,
wherein the environment adjusting device includes one or more types of equipment which controls one of lighting of the room, daylighting from outside the room, view of outside from the room, a volume of acoustic equipment, air conditioning, a height of a chair to be used by the user, tilt of a back of the chair, a height of a desk to be used by the user, display content of a display, and vibration characteristics of the room in association with movement of the mobile body.

5. The transport system according to claim 3,
wherein the physical condition information includes at least one of a heart rate, a blood pressure, a blood flow rate, an electrical signal obtained from a body, a body temperature, and judgment information based on image recognition.

6. The transport system according to claim 3,
wherein the processor is configured to:
acquire the physical condition information of the user through measurement equipment provided within the room at a predetermined timing; and
correct the adjustment information on the basis of the physical condition information acquired at the predetermined timing.

7. The transport system according to claim 3,
wherein the processor is configured to:
acquire action schedule of the user within the room; and
correct the adjustment information in accordance with the acquired action schedule.

8. An information processing apparatus comprising:
a processor configured to provide, on a basis of identification information for identifying a user who uses a room, adjustment information for adjusting an environment of the room for each user to a mobile body including the room and an environment adjusting device that adjusts the environment of the room.

9. The information processing apparatus according to claim 8, further comprising:
a storage configured to store the adjustment information set for each user in association with the identification information of the user.

10. The information processing apparatus according to claim 8,
wherein the processor is configured to:
acquire physical condition information indicating a physical condition of the user;
correct the adjustment information on a basis of the acquired physical condition information; and
provide the corrected adjustment information to the mobile body.

11. The information processing apparatus according to claim 10,
wherein the processor is configured to:
acquire the physical condition information of the user through measurement equipment provided within the room at a predetermined timing; and
correct the adjustment information on a basis of the physical condition information acquired at the predetermined timing.

12. The information processing apparatus according to claim 10,
wherein the processor is further configured to:
acquire action schedule of the user within the room; and
correct the adjustment information in accordance with the acquired action schedule.

13. An information processing method executed by a computer, comprising:
providing, on a basis of identification information for identifying a user who uses a room, adjustment information for adjusting an environment of the room for each user to a mobile body including the room and an environment adjusting device that adjusts the environment of the room.

14. The information processing method according to claim 13, further comprising:
storing in a storage the adjustment information set for each user in association with the identification information of the user.

15. The information processing method according to claim 13, comprising:
acquiring a physical condition information indicating a physical condition of the user;
correcting the adjustment information on a basis of the acquired physical condition information; and
providing the corrected adjustment information to the mobile body.

16. The information processing method according to claim 15, comprising:
acquiring the physical condition information of the user through measurement equipment provided within the room at a predetermined timing; and
correcting the adjustment information on a basis of the physical condition information acquired at the predetermined timing.

17. The information processing method according to claim 13, comprising:
acquiring action schedule of the user within the room; and
correcting the adjustment information in accordance with the acquired action schedule.
